(19) United States
(12) Patent Application Publication
(10) Pub. No.: US 2011/0281072 A1
(43) Pub. Date: Nov. 17, 2011

(54) LAMINABLE SHAPED GLASS ARTICLE AND METHOD OF MAKING THE SAME

(76) Inventors: Robert Sabia, Corning, NY (US); Ljerka Ukrainczyk, Painted Post, NY (US)

(21) Appl. No.: 13/080,941

(22) Filed: Apr. 6, 2011

Related U.S. Application Data
(60) Provisional application No. 61/345,330, filed on May 17, 2010.

(51) Int. Cl. B32B 3/00; C03B 23/02; C03C 21/00; C03C 19/00

(52) U.S. Cl. 428/156; 65/61; 65/30.14

(57) ABSTRACT

A laminable shaped glass article includes a flat-surface/curved-surface glass article. A flat-surface/flat-surface glass body is reformed into a curved-surface/curved-surface glass body. One of the curved surfaces of the curved-surface/curved-surface is planarized to form the flat-surface/curved-surface glass article.

### CROSS REFERENCE TO RELATED APPLICATIONS

This application claims the benefit of priority under 35 U.S.C. §119(e) of U.S. Provisional Application Ser. No. 61/345,330 filed on May 17, 2010, the content of which is relied upon and incorporated herein by reference in its entirety.

### BACKGROUND

The present invention relates to shaped glass articles that can be laminated to flat surfaces and to a method of making the laminable shaped glass articles.

FIG. 1 shows a shaped glass cover 1 intended for use as a cover for a flat display screen, such as found in mobile electronic devices. The glass cover 1 is made by reforming a flat glass sheet into a three-dimensional shape. The glass cover 1 has an exterior convex surface 3 and an interior concave surface 5. It has been challenging to incorporate the glass cover 1 into a flat display screen device, especially if such a device includes a touch screen. The touch screen typically must be in contact with the top glass cover to close the circuit and transfer the touch signal. As shown in FIG. 1, mounting of the glass cover 1 on a flat touch screen display or flat display screen 9 results in a large cavity 7 between the interior concave surface 5 of the glass cover 1 and the flat touch screen display or flat display screen. For a flat display screen (i.e., without a touch screen) only, the cavity 7 can be filled with an index-matching, optically-clear adhesive to enable sharper brightness and clarity of the display screen, when viewed through the glass cover 1, than possible with an air-filled cavity. However, it is desirable to minimize use of index-matching, optically-clear adhesive since this specialty adhesive is relatively expensive. Also, bubbles can form in the adhesive during mounting of the glass cover 1 on the flat display screen 9, which may affect display quality. Alignment of the glass cover 1 on the flat display screen 9 may also not be precise due to the curviness of the interior curved surface. For a flat touch screen display, such as one including a capacitative touch screen, there can be no cavity between the curved interior surface of the glass cover and the touch screen. If the touch screen is made of glass, laminating the touch screen directly to the curved interior surface of the glass cover would not be feasible. A polymer touch screen, e.g., touch screen on PET film such as made by Nisha, can be laminated to the curved interior surface of the glass cover if the curved interior surface is a simple curved surface with curvature only on one axis. However, if the curved interior surface of the glass surface is part of a sphere or a spline surface, then even lamination of a polymer touch screen to the curved interior surface would not be possible. Consequently, the ability to make a flat touch screen display with a curved uniform thickness piece of glass laminated to the touch screen is limited to forming to a very simple two-dimensional curve. Even with a simple spherical curvature in one axis, once the touch screen is laminated, there still remains the above described challenge with flat display integration.

### SUMMARY

In a first aspect of the present invention, a laminable shaped glass article comprises an optically-clear, flat-surface/curved-surface glass body.

In a second aspect of the present invention, a method of making a laminable shaped glass article comprises reforming a flat-surface/flat-surface glass body into a curved-surface/curved-surface glass body, and planarizing one of the curved surfaces of the curved-surface/curved-surface glass body to form a flat-surface/curved-surface glass article, the flat-surface/curved-surface glass article being the laminable shaped glass article.

In a third aspect of the present invention, a method of making a laminable shaped glass article comprises reforming a flat-surface/flat-surface glass sheet into a sheet comprising a plurality of curved-surface/curved-surface glass bodies, extracting the curved-surface/curved-surface glass bodies from the sheet of curved-surface/curved-surface glass bodies, and planarizing one of the curved surfaces of at least one of the curved-surface/curved-surface glass bodies to form a flat-surface/curved-surface glass article, the flat-surface/curved-surface glass article being the laminable shaped glass article.

Other aspects of the present invention will be apparent from the following description and the appended claims.

### BRIEF DESCRIPTION OF DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 shows a prior art shaped glass cover mounted on a display screen.

FIG. 2 shows a laminable shaped glass article according to an embodiment of the present invention.

FIG. 3 shows the laminable shaped glass article of FIG. 2 mounted on a flat touch screen and display screen.

FIG. 4 is a process flow describing how to make a laminable shaped glass article such as shown in FIG. 2.

FIG. 5 is a flat-surface/convex-surface glass article superimposed on a concave-surface/convex-surface glass body.

FIG. 6 is a flat-surface/concave-surface glass article superimposed on a concave-surface/convex-surface glass body.

FIG. 7 is a variant of the process flow shown in FIG. 4.

FIG. 8 is a slice through a sheet of curved-surface/curved-surface glass bodies.

FIG. 9 is another variant of the process flow shown in FIG. 4.

### DETAILED DESCRIPTION

In the convention used in this disclosure, a M-surface/N-surface glass sheet, body, or article has a M-surface and an N-surface, where the N-surface is in opposing relation to the M-surface and is separated from the M-surface by a thickness of glass material, where the thickness may or may not be uniform.

A laminable shaped glass article according to one or more embodiments of the present invention has two opposing surfaces separated by a thickness of glass material. One of the opposing surfaces is a curved (three-dimensional) surface, and the other of the opposing surfaces is a flat (two-dimensional) surface. The laminable shaped glass article may also be referred to as a flat-surface/curved-surface glass article. The curved surface of the laminable shaped glass article may be selected from concave or convex surfaces, spherical or non-spherical surfaces, and cylindrical or non-cylindrical surfaces. The non-spherical or non-cylindrical surfaces may be continuous or multi-patch geometric spline surfaces. In one or more embodiments, the curved and flat surfaces are smooth, e.g., with roughness of 10 nm RMS or less. In one or more embodiments, the laminable shaped glass article is optically clear, i.e., does not have defects or coatings that could negatively affect its optical transmission, clarity, or performance. In one or more embodiments, the laminable shaped glass article may be used as a cover for a flat display screen or can be laminated to a touch screen, followed behind by a flat display.

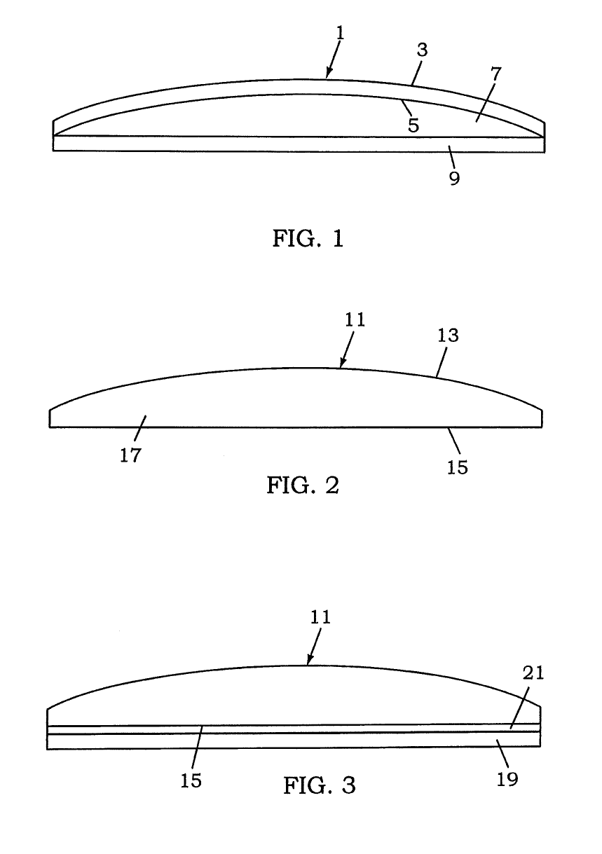

FIG. 2 shows a laminable shaped glass article 11 according to one embodiment of the present invention, with a curved surface 13 and a flat surface 15 separated by a thickness of glass material 17. The curved surface 13 is a convex, continuous geometric spline surface. FIG. 3 shows the laminable shaped glass article 11 mounted on a flat object 19. In one embodiment, the flat object 19 represents a flat display screen. In another embodiment, the flat object 19 represents a flat touch screen. A layer of index-matched, optically-clear adhesive 21 is disposed between the flat surface 15 of the laminable shaped glass article 11 and the flat touch screen or flat display screen 19 to secure the laminable shaped glass article 11 to the flat touch screen or flat display screen 19. Unlike the example described in prior art FIG. 1, only a thin layer of adhesive 21 is needed because the flat surface 15 mounts flatly on the flat touch screen or the flat display screen 19.

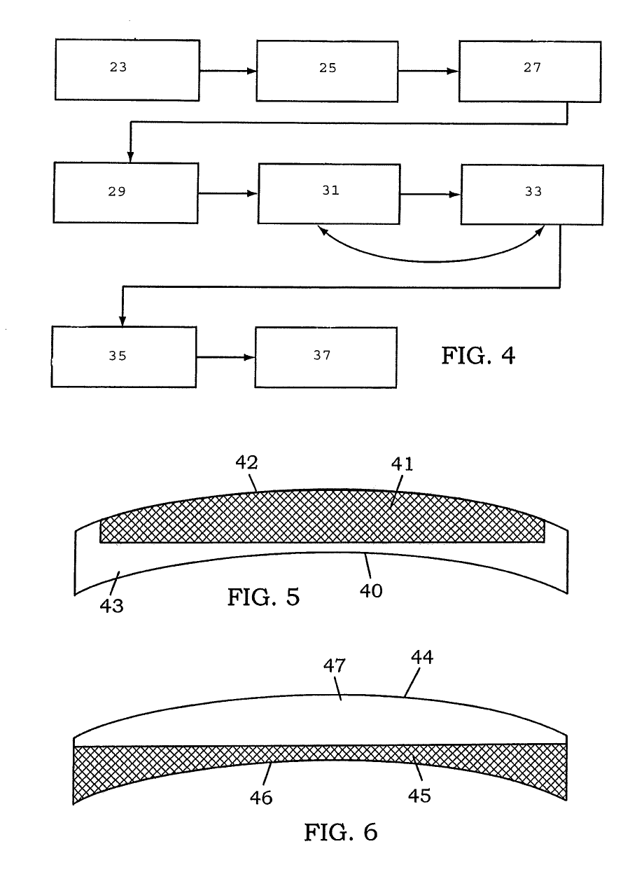

FIG. 4 is a process flow describing how to make a laminable shaped glass article as described above. A flat (flat-surface/flat-surface) glass sheet is provided (23). The flat glass sheet may be made by any suitable process, e.g., fusion draw or float process. Fusion draw is generally preferred because it can deliver a glass sheet with surfaces of fire-polished quality. The flat glass sheet is divided into flat (flat-surface/flat-surface) glass bodies (25). Dividing may be by scoring and breaking. Scoring may be with a laser source, i.e., laser scoring. Each of the flat glass bodies is reformed into a curved-surface/curved-surface glass body (27). Reforming can be thermal reforming. There are various methods for thermally reforming a flat glass body into a curved-surface/curved-surface glass body. In one class of these methods, the flat glass body is placed above a mold and heated along with the mold. The flat glass body is then sagged into the mold cavity. The heating scheme may be differential so that the mold is substantially cooler than the flat glass body at the time the flat glass body is sagged into the mold. This differential heating scheme is described in U.S. patent application Ser. No. 12/493,674, filed on 29 Jun. 2009. Typically, the flat glass body will be heated to a temperature between the softening point and annealing point of the glass. The mold has a contoured surface that determines the shape of the curved-surface/curved-surface glass body formed by sagging of the flat glass body into the mold cavity. Sagging may be assisted by vacuum. Thermal reforming may also be by pressing a heated flat glass body with a heated shaped plunger. The curved-surface/curved-surface glass body produced after reforming has two opposing surfaces separated by a uniform thickness of glass material, where the opposing surfaces are both curved surfaces. There are several advantages of using of using thermal forming over machining glass to create a curved glass surface: (1) thermal forming can produce a complex surface shape at low cost and high throughput, while machining a complex curve in glass is very costly, with long cycle time, usually requiring deterministic lapping and polishing, (2) polishing any curved surface to remove machining marks from prior coarser steps is costly and requires at least 10-μm uniform removal of material over the entire curved surface, and (3) machined glass always has some level of subsurface damage, which reduces its strength and makes it less damage-resistant than thermally formed piece of glass.

If thermal reforming is used, the curved-surface/curved-surface glass bodies are cooled down or allowed to cool down, e.g., to a temperature below the annealing point or strain point of the glass. The curved-surface/curved-surface glass bodies are then subjected to annealing (29). After annealing, unwanted material is machined off the periphery of each curved-surface/curved-surface glass bodies (31). A computer numerically controlled (CNC) machine tool may be used for this purpose. Other features such as depressions, holes, and slots may also be machined into a surface of each curved-surface/curved-surface glass body, as required by the design of the final glass article. The process flow includes planarizing the curved-surface/curved-surface glass bodies to generate flat-surface/curved-surface glass articles (33). A flat-surface/curved-surface glass body has two opposing surfaces, where one of the opposing surfaces is flat and the other is curved. Planarizing of the curved-surface/curved-surface glass bodies (33) may come before or after the machining of the curved-surface/curved-surface glass bodies (31). During the planarizing step (33), one of the curved surfaces of each curved-surface/curved-surface glass body is planarized into a flat surface, thereby achieving a flat-surface/curved-surface glass article as described above. Planarizing can be any combination of grinding, lapping, and polishing. A typical sequence may be grinding, for fast removal of material, followed by lapping, for reduction of coarseness of the ground surface, followed by polishing, to achieve a desired surface roughness, e.g., surface roughness of 1.5 nm RMS or less. The curved-surface/curved-surface glass body may be mounted on a support, e.g., a vacuum chuck, in a manner to expose the curved surface to be planarized. Then, a suitable planarizing tool may be used to planarize the exposed curved surface. To enable the planarizing step (33), the thickness of the flat glass sheet in the providing step (23) must be sufficient (i.e., much greater than the final thickness of the flat-surface/curved-surface glass article) to accommodate planarizing of the curved surface into a flat surface. FIG. 5 shows a flat-surface/convex-surface glass article 41 generated by planarizing the concave surface 40 of a concave-surface/convex-surface glass body 43. The convex surface of the flat-surface/convex-surface glass article 41 is a continuous geometric spline surface. The flat-surface/convex-surface glass article 41 is superimposed on the concave-surface/convex-surface glass body 43 for comparison purposes. Similarly, FIG. 6 shows a flat-surface/concave-surface glass article 45 generated by planarizing the convex surface 44 of a concave-surface/convex-surface glass body 47. The concave surface 46 of the flat-surface/concave-surface glass article 45 is a continuous geometric spline surface. The flat-surface/concave-surface glass article 45 is superimposed on the concave-surface/convex-surface glass body 47 for comparison purposes.

Returning to FIG. 4, after the planarizing step (33) or the machining step (31), the flat-surface/curved-surface glass articles are subjected to chemical strengthening (35). In one or more embodiments, chemical strengthening involves an ion-exchange process. For ion-exchange, the flat-surface/curved-surface glass articles (and by implication the glass sheet in the providing step (23)) must be made of an ion-exchangeable glass. Ion-exchangeable glasses are alkali-containing glasses with smaller alkali ions, such as Li⁺ and/or Na⁺, that can be exchanged for larger alkali ions, e.g., K+, during an ion-exchange process. Examples of suitable ion-exchangeable glasses are described in U.S. patent application Ser. Nos. 11/888,213, 12/277,573, 12/392,577, 12/393,241, and 12/537,393, U.S. Provisional Application Nos. 61/235,767 and 61/235,762 (all assigned to Corning Incorporated), the contents of which are incorporated herein by reference. These glasses can be ion-exchanged at relatively low temperatures and to a depth of at least 30 μm. A process for strengthening glass by ion-exchange is described in, for example, U.S. Pat. No. 5,674,790 (Araujo, Roger J.). Generally, the process involves immersing the subject glass in a molten bath containing an alkali salt with alkali ions that are larger than the alkali ions in the subject glass. The smaller alkali ions in the subject glass are exchanged for the larger alkali ions in the bath. The process is typically carried out at an elevated temperature range that does not exceed the transition temperature of the glass. The ion-exchange is followed by removal of the subject glass from the bath and subsequent cooling down of the subject glass. For the purpose of the process flow of FIG. 4, the subject glass represents each flat-surface/curved-surface glass article to be chemically strengthened by ion-exchange. The final step in the process flow is to inspect the flat-surface/curved-surface glass articles for defects (37).

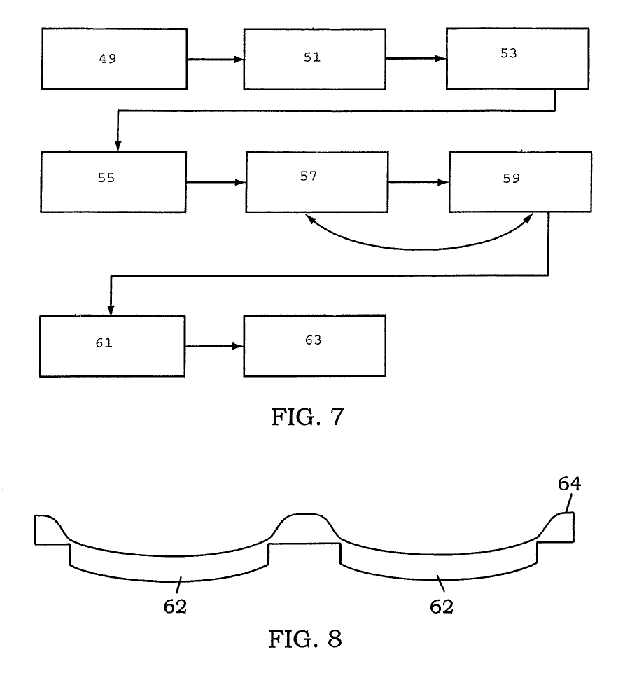

FIG. 7 is a variant of the process flow described in FIG. 4. As much as possible, references will be made to previously described material to avoid unnecessary repetition. The process flow in FIG. 7 starts with providing a flat glass sheet (49), as in the providing step (23) of FIG. 4. Next, the flat glass sheet is reformed into a sheet of curved-surface/curved-surface glass bodies (51). FIG. 8 is a slice through an example sheet of curved-surface/curved-surface glass bodies and shows a plurality of curved-surface/curved-surface glass bodies 62 formed at different locations on a single sheet 64. The sheet of curved-surface/curved-surface glass bodies could be made by thermal reforming, for example, by heating and sagging the flat glass sheet into a mold having a plurality of mold cavities, where each mold cavity is defined by a suitably contoured surface. The sheet of curved-surface/curved-surface glass bodies is subjected to an annealing step (53), as in the annealing step (29) of FIG. 4. Then, the curved-surface/curved-surface glass bodies are extracted from the sheet of curved-surface/curved-surface glass bodies, i.e., by dividing or dicing the sheet of curved-surface/curved-surface glass bodies (55). The peripheries of the curved-surface/curved-surface glass bodies are machined (57) to remove unwanted material, as in the machining step (31) of FIG. 4. The machining step (57) may also include forming features in the curved-surface/curved-surface glass bodies. The curved-surface/curved-surface glass bodies are planarized to flat-surface/curved-surface glass articles (59), as in the planarizing step (33) of FIG. 4. The planarizing step (59) may come before or after the machining step (57). The process flow includes a chemical-strengthening step (61), as in the chemical-strengthening step (35) of FIG. 4, and an inspection step (63), as in the inspection step (37) of FIG. 4.

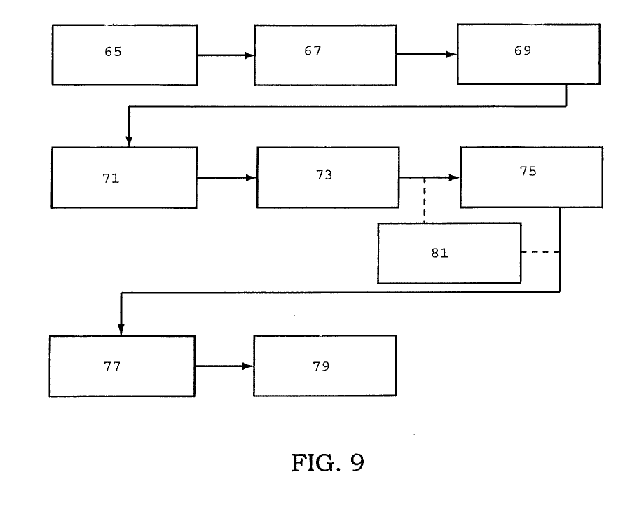

FIG. 9 is a variant of the process flow of FIG. 4. As much as possible, references will be made to previously described material to avoid unnecessary repetition. The process flow in FIG. 9 starts with providing a flat glass sheet (65), as in the providing step (23) of FIG. 4. The process continues with dividing the flat glass sheet into flat glass bodies (67), as in the dividing step (25) of FIG. 4. Next, the periphery of each flat glass body is machined to remove any unwanted material (69). The machined flat glass bodies are each reformed to produce curved-surface/curved-surface glass bodies (71), as in the reforming step (27) of FIG. 4. After reforming, each curved-surface/curved-surface glass body is subjected to annealing (73), as in the annealing step (29) of FIG. 4, followed by planarizing (75), as in the planarizing step (33) of FIG. 4. The flat-surface/curved-surface glass articles resulting from the planarizing step (33) may be subjected to chemical strengthening (77), as in the chemical strengthening step (35) of FIG. 4, and inspection (79), as in the inspection step (37) of FIG. 4. A second machining step (81), as in machining step (31) of FIG. 4, may be applied to the curved-surface/curved-surface glass bodies before the planarizing step (75).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of making a laminable shaped glass article, comprising:
reforming a flat-surface/flat-surface glass body into a curved-surface/curved-surface glass body; and
planarizing one of the curved surfaces of the curved-surface/curved-surface glass body to form a flat-surface/curved-surface glass article, the flat-surface/curved-surface glass article being the laminable shaped glass article.

2. The method of claim 1, further comprising:
providing a flat-surface/flat-surface glass sheet; and
dividing the flat-surface/flat-surface glass sheet into a plurality of flat-surface/flat-surface glass bodies, the flat-surface/flat-surface glass body in step (a) being one of the plurality of flat-surface/flat-surface glass bodies.

3. The method of claim 2, further comprising repeating the reforming step and the planarizing step for additional ones of the flat-surface/flat-surface glass bodies.

4. The method of claim 1, further comprising annealing the curved-surface/curved-surface glass body prior to the planarizing step.

5. The method of claim 1, further comprising machining a periphery of the curved-surface/curved-surface glass body to remove unwanted material after the planarizing step.

6. The method of claim 1, further comprising machining a periphery of the curved-surface/curved-surface glass body to remove unwanted material prior to the planarizing step.

7. The method of claim 1, further comprising chemically strengthening the flat-surface/curved-surface glass article by ion-exchange after the planarizing step.

8. The method of claim 1, further comprising providing the flat-surface/flat-surface glass body as an ion-exchangeable glass.

9. A method of making a laminable shaped glass article, comprising:
reforming a flat-surface/flat-surface glass sheet into a sheet comprising a plurality of curved-surface/curved-surface glass bodies;
extracting the curved-surface/curved-surface glass bodies from the sheet of curved-surface/curved-surface glass bodies; and
planarizing one of the curved surfaces of at least one of the curved-surface/curved-surface glass bodies to form a flat-surface/curved-surface glass article, the flat-surface/curved-surface glass article being the laminable shaped glass article.

10. The method of claim 9, further comprising annealing the at least one of the curved-surface/curved-surface glass bodies prior to the planarizing step.

11. The method of claim 9, further comprising machining a periphery of the at least one of the curved-surface/curved-surface glass bodies to remove unwanted material prior to the planarizing step.

12. The method of claim 9, further comprising chemically strengthening the flat-surface/curved-surface glass article by ion-exchange after the planarizing step.

13. The method of claim 9, further comprising repeating the planarizing step for additional ones of the curved-surface/curved-surface glass bodies.

14. A laminable shaped glass article comprises an optically-clear, flat-surface/curved-surface glass body.

15. The laminable shaped glass article of claim 14, wherein the curved surface of the flat-surface/curved-surface glass body is a convex surface.

16. The laminable shaped glass article of claim 14, wherein the curved surface of the flat-surface/curved-surface glass body is a concave surface.

17. The laminable shaped glass article of claim 14, wherein the curved surface of the flat-surface/curved-surface glass body is a geometric spline surface.
